(19) United States
(12) Patent Application Publication
(10) Pub. No.: US 2025/0159600 A1
(43) Pub. Date: May 15, 2025

(54) SYSTEMS AND METHODS FOR SERVICE BASED MOBILITY MANAGEMENT ENTITY SELECTION USING ENHANCED NAS NODE SELECTION FUNCTION (NNSF) ALGORITHM

(71) Applicant: RAKUTEN SYMPHONY, INC., Tokyo (JP)

(72) Inventor: Raghavendra, Bangalore (IN)

(21) Appl. No.: 18/388,530

(22) Filed: Nov. 10, 2023

(51) Int. Cl. H04W 48/20; H04W 48/16

(52) U.S. Cl. CPC H04W 48/20; H04W 48/16

(57) ABSTRACT

A system for selecting a mobile management entity (MME) includes a non-transitory computer readable medium configured to store instructions thereon and a processor. The processor is configured to determine a pool of MMEs available for connecting to a user equipment (UE). The processor is configured to identify, from the pool of MMEs, a plurality of lists of MMEs, wherein each of the plurality of lists of MMEs includes MMEs having a same service type. The processor is configured to determine a service type of the UE. The processor is configured to select a first MME from the pool of MMEs using a node selection algorithm, wherein the node selection algorithm is executed for a single list of the plurality of lists of MMEs, and the service type of the single list matches the UE service type. The processor is configured to connect the UE to the first MME.

### TECHNICAL FIELD

This description relates to a system for Mobility Management Entity (MME) selection and a method of using a system.

### BACKGROUND

An eNodeB (eNB) is used to connect user equipment (UE) to a wireless network. In order to facilitate the connection between the UE and the wireless network, a mobile management entity (MME) is utilized in some approaches to support authentication of the UE, roaming and handover of the UE. Each eNB is capable of communicating with multiple MMEs in order to provide load balancing and for redundancy to account for a situation where an MME is not available. In some approaches, the eNB relies on a NAS node selection function (NNSF) for MME selection. In some approaches the NNSF is implemented using a Round Robin algorithm or a Weight Based algorithm for load balancing in the wireless network. The Round Robin algorithm utilizes a queue for MME selection where after selection of a specific MME, the MME is removed from the front of the queue and added to the end of the queue. The Weight Based algorithm utilizes available MMEs that are arranged in a weighted fashion based on a capacity of each MME and MMEs are selected based on weight with no MME selected in consecutive selections.

In some approaches, MMEs were used to support only Long Term Evolution (LTE) services. However, as new communication technologies are utilized new MME services are sought.

### SUMMARY

A system for selecting a mobile management entity (MME) includes a non-transitory computer readable medium configured to store instructions thereon. The system further includes a processor connected to the non-transitory computer readable medium. The processor is configured to execute the instructions for determining a pool of MMEs available for connecting to a user equipment (UE). The processor is further configured to execute the instructions for identifying, from the pool of MMEs, a plurality of lists of MMEs, wherein each of the plurality of lists of MMEs includes only MMEs having a same service type. The processor is further configured to execute the instructions for determining a service type of the UE. The processor is further configured to execute the instructions for selecting a first MME from the pool of MMEs using a node selection algorithm, wherein the node selection algorithm is executed for a single list of the plurality of lists of MMEs, and the service type of the single list matches the service type of the UE. The processor is further configured to execute the instructions for connecting the UE to the first MME.

A method of selecting a mobile management entity (MME) includes determining a pool of MMEs available for connecting to a user equipment (UE). The method further includes identifying, from the pool of MMEs, a plurality of lists of MMEs, wherein each of the plurality of lists of MMEs includes only MMEs having a same service type. The method further includes determining a service type of the UE. The method further includes selecting a first MME from the pool of MMEs using a node selection algorithm, wherein the node selection algorithm is executed for a single list of the plurality of lists of MMEs, and the service type of the single list matches the service type of the UE. The method further includes connecting the UE to the first MME.

A non-transitory computer readable medium configured to store instructions thereon. The instructions are configured to cause a processor to perform determining a pool of MMEs available for connecting to a user equipment (UE). The instructions are configured to cause a processor to perform identifying, from the pool of MMEs, a plurality of lists of MMEs, wherein each of the plurality of lists of MMEs includes only MMEs having a same service type. The instructions are configured to cause a processor to perform determining a service type of the UE. The instructions are configured to cause a processor to perform selecting a first MME from the pool of MMEs using a node selection algorithm, wherein the node selection algorithm is executed for a single list of the plurality of lists of MMEs, and the service type of the single list matches the service type of the UE. The instructions are configured to cause a processor to perform connecting the UE to the first MME.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a network system, in accordance with some embodiments.

FIG. 2 is a flowchart of a method of using a network system, in accordance with some embodiments.

FIG. 3 is a flowchart of a method of using a network system, in accordance with some embodiments.

FIG. 4 is a flowchart of a method of using a network system, in accordance with some embodiments.

FIG. 5 is a flowchart of a method of using a network system, in accordance with some embodiments.

FIG. 6 is a flowchart of a method of using a network system, in accordance with some embodiments.

FIG. 7 is a block diagram of computer architecture in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

As new communication technologies are introduced, new uses of mobile management entity (MME) components would help to facilitate connection of devices to wireless networks. One such technology is narrowband Internet of Things (NB-IoT). In other approaches, MMEs only provided LTE services. In these approaches, bottlenecks are prone to occur when an eNodeB (eNB) performs MME selection due to the growth of NB-IoT. Examples of bottlenecks include improper load balancing amongst the MMEs, which increases a risk of poor user experience during connection to the network.

For example, in a Round Robin algorithm that includes MME resources for both LTE service and NB-IoT service, an observation was made that a same MME was repeatedly selected for each type of service instead of rotating amongst the MMEs for each type of service. Table 1 below provides an example of deficiencies in a selection process using the Round Robin algorithm according to other approaches.

TABLE 1

| | | | Round Robin Algorithm Flaw | | | | | | |
|---|---|---|---|---|---|---|---|---|---|
| | | | | MME Service Type | Ite | Ite | nbiot | nbiot | |
| | | | | MME Name | A | B | C | D | |
| UE Attach Order | | | | | MME Selection Order | | | | |
| LTE | NBIOT | LTE | NBIOT | | A | C | A | C | Actual |
| | | | | | A | C | B | D | Expected |

As another example, in a Weight Based algorithm that includes MME resources for both LTE service and NB-IoT service, an observation was made that consecutive selections for a same type of service resulted in the selection of a same MME resource repeatedly. Table 2 below provides an example of deficiencies in a selection process using the Weight Based algorithm according to other approaches.

TABLE 2

| | | | Weight Based Algorithm Flaw Case 1 | | | | | | |
|---|---|---|---|---|---|---|---|---|---|
| | | | | MME Service Type | Ite | Ite | nbiot | nbiot | |
| | | | | MME Name | A | B | C | D | |
| | | | | Absolute Weight | 4 | 3 | 2 | 1 | |
| UE Attach Order | | | | | MME Selection Order | | | | |
| LTE | NBIOT | LTE | NBIOT | | A | C | A | C | Actual |
| | | | | | A | C | B | D | Expected |

There are several instances wherein technological evolution creates inconsistencies or incompatibilities between previous capabilities and newly introduced capabilities. In some instances, technologies become stale, outdated or become unable to provide support for newly introduced capabilities. In some instances, technologies are built with specific parameters or limitations that are unable to accommodate growth or unanticipated introduction of technology features.

In some instances, telecommunications, wireless, or cellular technology becomes outdated due to the rapid evolution or use of technology in the wireless or cellular technology area. As a result, rapid adaptability and new solutions are used to accommodate rapidly changing broadband cellular network technology.

In some instances, a shift in technological capabilities or features is observable between the introduction of Mobility Management Entity (MME) Service Types such as the introduction of a NarrowBand-Internet of Things (NB-IoT) MME Service Type onto the LTE Service Type landscape.

In some more specific instances, some load balancing methods have been rendered inefficient or inaccurate from continued use in the setting of a changing technological landscape. In some instances, load balancing methods previously used produce unexpected, poor performance or inefficient use of server resources. That is, a technological mismatch or deficiency in accommodating new technology has occurred.

In order to help reduce or solve these problems associated with technological evolution or shifts described, the current description includes systems and methods that accommodate evolving MME Service Types. The current description includes systems and methods that allow for more appropriate or more efficient load balancing. The current description includes systems and methods to more efficiently distribute load amongst server resources. As a result, the current description includes systems and methods that are able to address deficiencies associated with technological mismatches or outdated architecture.

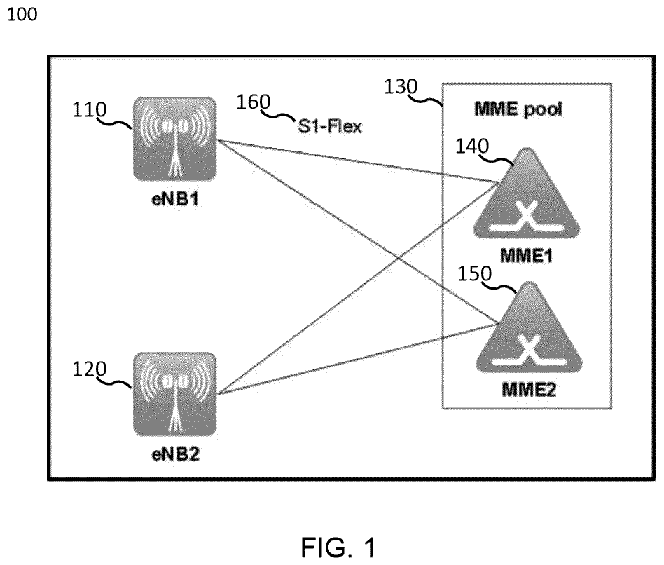

FIG. 1 is a schematic diagram of a network system 100, in accordance with some embodiments. The network system 100 includes a first evolved NodeB (eNB), “eNB1” (110). The network system 100 includes a second eNB, “eNB2” (120). The first eNB 110 and second eNB 120 are each configured to communicate with each member a Mobile Management Entity (MME) pool 130. MME pool 130 includes a first MME, “MME1” 140. MME pool 130 includes a second MME, “MME2” 150. The first eNB 110 and second eNB 120 are each configured to communicate through an SI Flex 160 protocol with each member of Mobile Management Entity (MME) pool 130. In some embodiments, network system 100 utilizes LTE. In some embodiments, eNBs are each configured to select, by an SI Flex protocol or mechanism, a member of Mobile Management Entity (MME) pool. In some embodiments, eNBs are each configured to allocate load, by an SI Flex protocol, a member of Mobile Management Entity (MME) pool. In some embodiments, an SI Flex protocol or mechanism allowed an eNB to be connected to more than one MME. While the network system 100 includes two eNBs, one of ordinary skill in the art would recognize that any number of eNBs are within the scope of this description. While the network system 100 includes single MME pool, one of ordinary skill in the art would recognize that any number of MME pools are within the scope of this description. While the network system 100 includes two MMEs, one of ordinary skill in the art would recognize that any number of MMEs are within the scope of this description.

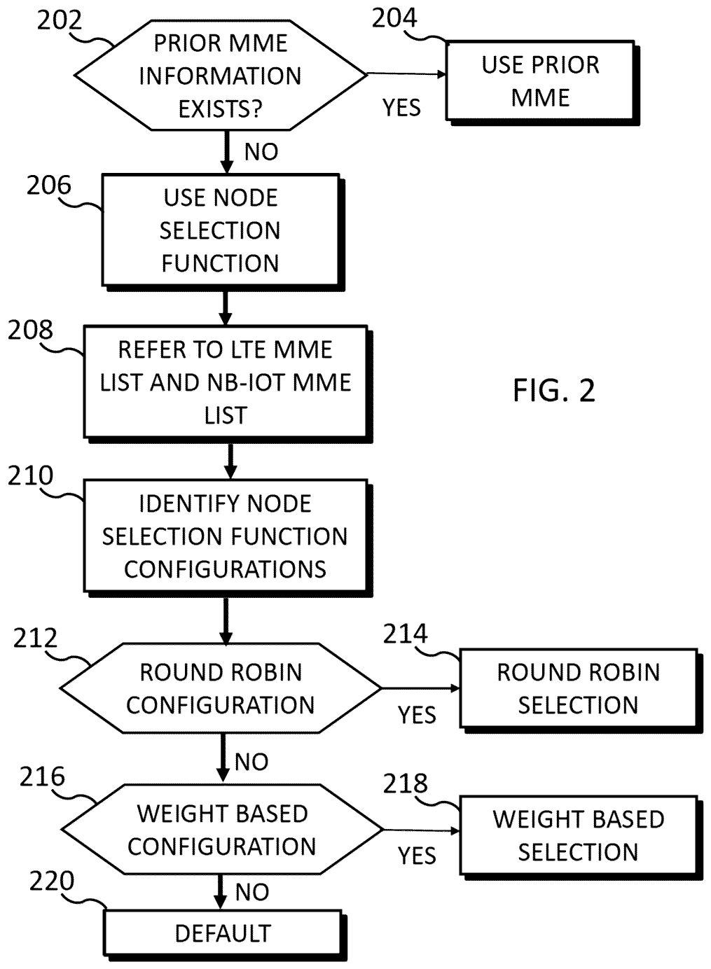

FIG. 2 is a flowchart of a method 200 of using a network system, in accordance with some embodiments. The method 200 is usable by a network system in order to help ensure that load is efficiently balanced amongst MMEs. By utilizing efficient load balancing, the method 200 helps to manage resource distribution. In some embodiments, the method 200 is able to be executed by the network system 100 (FIG. 1). In some embodiments, the method 200 is able to be executed by a network system other than the network testing system 100 (FIG. 1).

In operation 202, a determination is made whether any prior MME usage information exists for an eNB, e.g., eNB 110 (FIG. 1). In some embodiments, prior MME usage information is stored in association with an eNB. In some embodiments, prior MME usage information is cached in association with an eNB. In some embodiments, prior MME usage information includes metadata. In some embodiments, prior MME usage information is accessible from a remote source by an eNB. In some embodiments, prior MME usage information includes an identifier of an MME to which an eNB was previously connected. In some embodiments, prior MME usage information includes information associated with an MME to which an eNB was previously connected. In some embodiments, prior MME usage information includes information associated with an MME to which an eNB was previously in communication with. In some embodiments, prior MME usage information includes information associated with an MME to which an eNB was previously in communication with during a particular time interval or timeframe.

In operation 204, an eNB, e.g., eNB 110 (FIG. 1), uses a prior MME based on a determination that prior MME information exists in operation 202. In some embodiments, a determination is made that an eNB was previously connected to an MME. In some embodiments, a determination that an eNB was previously connected to an MME or that operation 204 has been executed, an operation to perform or use a node selection function is bypassed. For example, in some embodiments, operation 206 is bypassed in response to, or when, operation 204 is entered or executed.

In operation 206, an eNB, e.g., eNB 110 (FIG. 1), executes a node selection function based on a determination that no prior MME information exists in operation 202. In some embodiments, an eNB executes a node selection function based on a configuration or preference. In some embodiments, an eNB executes a node selection function based on a partial lack of prior used MME information. In some embodiments, entry or execution of operation 206 causes an identifying or referring to a data structure. In some embodiments, a data structure includes a listing of one or more LTE MMEs. A listing includes a group of available MMEs for a specific service type, such as LTE or NB-IoT. In some embodiments, the MMEs in a listing are identified based on unique identifications within a particular network, such as MME code (MMEC), MME group identity (MMEGI) or MME identifier (MMEI). IN some embodiments, the MMEs in a listing are identified based on unique identifications globally, such as public land mobile network identifier (PLMN-ID), MMEI or globally unique MMEI (GUMMEI). In some embodiments, a data structure includes a listing of one or more NB-IoT MMEs. In some embodiments, a data structure includes a listing of one or more LTE MMEs and one or more NB-IoT MMEs. In some embodiments, a data structure includes a listing of one or more LTE MMEs and a separate listing of one or more NB-IoT MMEs. In some embodiments, a listing of one or more LTE MMEs includes an index associated with each member of the listing. In some embodiments, the index of an MME identifies a type of service provided by the MME, such as LTE or NB-IoT, as well as a position of the MME within the list of MMEs having that service type. In some embodiments, a data structure including a listing of one or more LTE MMEs includes an index, reference, variable, identifier, or pointer associated with a current member of the listing. In some embodiments, a listing of one or more NB-IoT MMEs includes an index associated with each member of the listing. In some embodiments, a data structure including a listing of one or more NB-IoT MMEs includes an index, reference, variable, identifier, or pointer associated with a current member of the listing. In some embodiments, a data structure includes a listing of one or more LTE MMEs associated with a first index associated with each member of the LTE MME listing and a separate listing of one or more NB-IoT MMEs associated with a second index associated with each member of the NB-IoT MME listing. In some embodiments, a data structure includes a listing of one or more LTE MMEs associated with a first index associated with a particular member of the LTE MME listing and a separate listing of one or more NB-IoT MMEs associated with a second index associated with a particular member of the NB-IoT MME listing. In some embodiments, a particular member of a listing is a current member being used in a node selection process. In some embodiments, a data structure other than a list is used. In some embodiments, a data structure including a list and a data structure other than a list is used. In some embodiments, various data structures are used together. One of ordinary skill in the art would understand that any type of data structure is usable for embodiments described herein. For example, without limitation, arrays, vectors, linked lists, etc, are within the scope of embodiments described herein.

In operation 208, a reference is made to a data structure including a listing of LTE MMEs and NB-IoT MMEs in an MME pool. A pool is a listing of available MMEs to which an eNB is able to connect. In some embodiments, a data structure is referenced locally at an eNB. In some embodiments, a data structure is referenced remotely from an eNB.

In operation 210, node selection function configurations are identified. In some embodiments, node selection function configurations include specification of a selection function algorithm to be used in node selection. In some embodiments, node selection function configurations include a specification of a selection function algorithm to be used in node selection comprising a Round Robin algorithm. In some embodiments, node selection function configurations include a specification of a selection function algorithm to be used in node selection comprising a Weight Based algorithm. In some embodiments, node selection function configurations include a specification of data structures, or their contents, as described in operations 206 and 208, or elsewhere herein. In some embodiments, the node selection function configuration is determined based on data stored in the eNB. In some embodiments, the node selection function configuration is determined based on a received input from a network operator. In some embodiments, the node selection function configuration is determined based on whether MMEs identified in operation 208 have a same capacity. A capacity indicates a number of connections the MME is capable of effectively handling. For example, in some embodiments, in response to a determination that the MMEs identified in operation 208 have a same capacity, a Round Robin algorithm is identified as the node selection function configuration. In some embodiments, in response to determination that the MMEs identified in operation 208 have different capacities, a Weight Based algorithm is identified as the node selection function configuration.

In operation 212, a determination is made as to whether a Round Robin algorithm is specified in a configuration, such as the configuration in operation 210. In some embodiments, if it is determined that a Round Robin algorithm is specified in a configuration, operation 214 is executed. In some embodiments, if it is determined that a Round Robin algorithm is not specified in a configuration, operation 214 is not executed. In some embodiments, if it is determined that a Round Robin algorithm is not specified in a configuration, operation 214 is bypassed. In some embodiments, if it is determined that a Round Robin algorithm is not specified in a configuration, another determination operation is executed, such as in operation 216. In some embodiments, if it is determined that a Round Robin algorithm is not specified in a configuration, a default operation is executed, such as default operation 220.

In operation 214, a Round Robin algorithm is executed. In some embodiments, a Round Robin algorithm includes selecting a next element from a group of elements in a sequential manner. For example, in a set of three elements with identifiers of “1”, “2”, and “3”, the element with an identifier of “3” is selected next. In some embodiments, a position in a data structure acts as an identifier. For example, a position in a queue acts as an identifier.

In operation 216, a determination is made as to whether a Weight Based algorithm is specified in a configuration, such as the configuration in operation 210. In some embodiments, if it is determined that a Weight Based algorithm is specified in a configuration, operation 218 is executed. In some embodiments, if it is determined that a Weight Based algorithm is not specified in a configuration, operation 218 is not executed. In some embodiments, if it is determined that a Weight Based algorithm is not specified in a configuration, operation 218 is bypassed. In some embodiments, if it is determined that a Weight Based algorithm is not specified in a configuration, another determination operation is executed, such as in operation 212.

In operation 218, a Weight Based algorithm is executed. In some embodiments, a Weight Based algorithm includes selecting a next element from a group of elements based on assigned weights. For example, in a set of three elements with weights of “1”, “2”, and “3” assigned, the element with a weight of “3” assigned is selected next. In some embodiments, if it is determined that a Weight Based algorithm is not specified in a configuration, a default operation is executed, such as default operation 220.

In operation 220, a default operation is executed. In some embodiments, a default operation includes executing a round robin algorithm, according to embodiments here. In some embodiments, a default operation includes executing a Weight Based algorithm, according to embodiments here.

One of ordinary skill in the art would understand that additional operations are possible within method 200 in some embodiments. For example, in some embodiments, the method 200 further includes additional algorithm configuration identification steps. In some embodiments, an order of operations of the method 200 is changed. For example, in some embodiments the operation 216 is performed prior to the operation 212. In some embodiments, at least one operation of the method 200 is omitted. For example, in some embodiments, the operation 208 is omitted.

Utilizing the method 200 helps to ensure efficient load balancing amongst MMEs. As a result, network service is more likely to remain robust and reliable. For example, the method 200 utilizing a Round Robin algorithm was observed as having increased accuracy in comparison with other approaches. Table 3 below is an example of the accuracy of implementing a Round Robin algorithm for MME selection from method 200.

TABLE 3

| | | | Round Robin Algorithm Improvement | | | | | | |
|---|---|---|---|---|---|---|---|---|---|
| | | | | MME Service Type | Ite | Ite | | | |
| | | | | MME Name | A | B | | | |
| | | | | MME Service Type | nbiot | nbiot | | | |
| | | | | MME Name | C | D | | | |
| UE Attach Order | | | | | MME Selection Order | | | | |
| LTE | NBIOT | LTE | NBIOT | | A | C | B | D | Actual |
| | | | | | A | C | B | D | Expected |

Additionally, the method 200 utilizing a Weight Based algorithm was also observed as having increased accuracy in comparison with other approaches. Table 4 below is an example of the accuracy of implementing a Weight Based algorithm for MME selection from method 200.

TABLE 4

| | | | Weight Based Algorithm Improvement Case 1 | | | | | | |
|---|---|---|---|---|---|---|---|---|---|
| | | | | MME Service Type | Ite | Ite | | | |
| | | | | MME Name | A | B | | | |
| | | | | Absolute Weight | 4 | 3 | | | |
| | | | | MME Service Type | nbiot | nbiot | | | |
| | | | | MME Name | C | D | | | |
| | | | | Absolute Weight | 2 | 1 | | | |
| UE Attach Order | | | | | MME Selection Order | | | | |
| LTE | NBIOT | LTE | NBIOT | | A | C | B | C | Actual |
| | | | | | A | C | B | D | Expected |

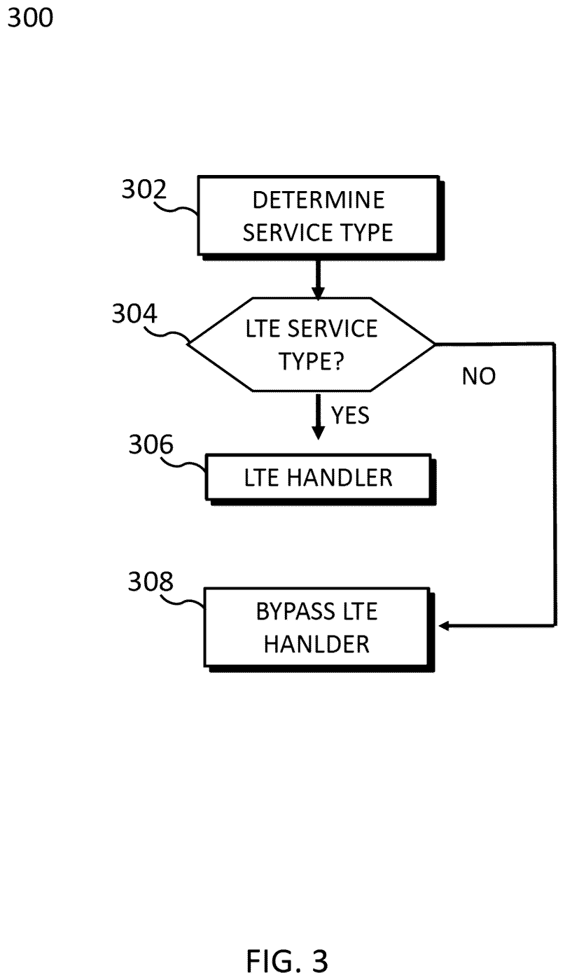

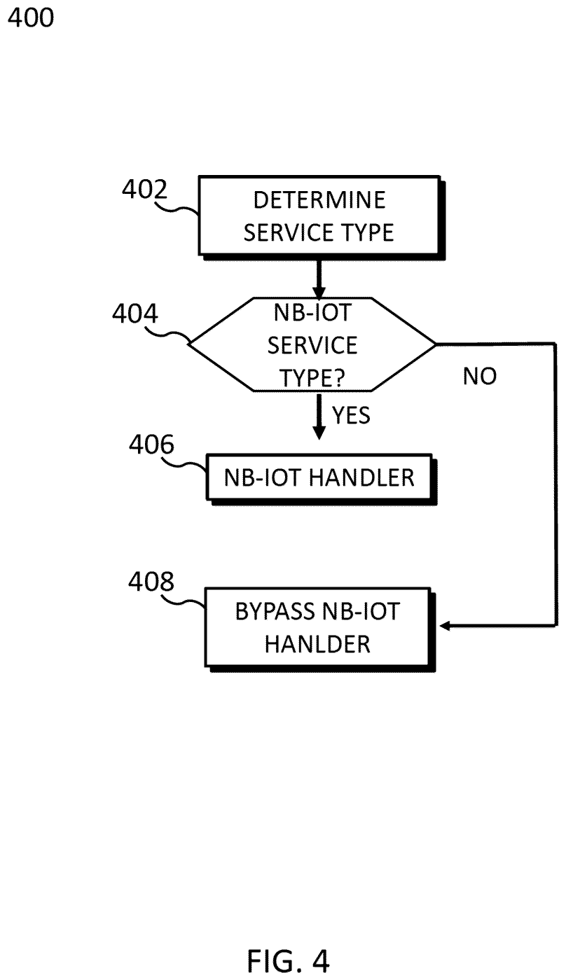

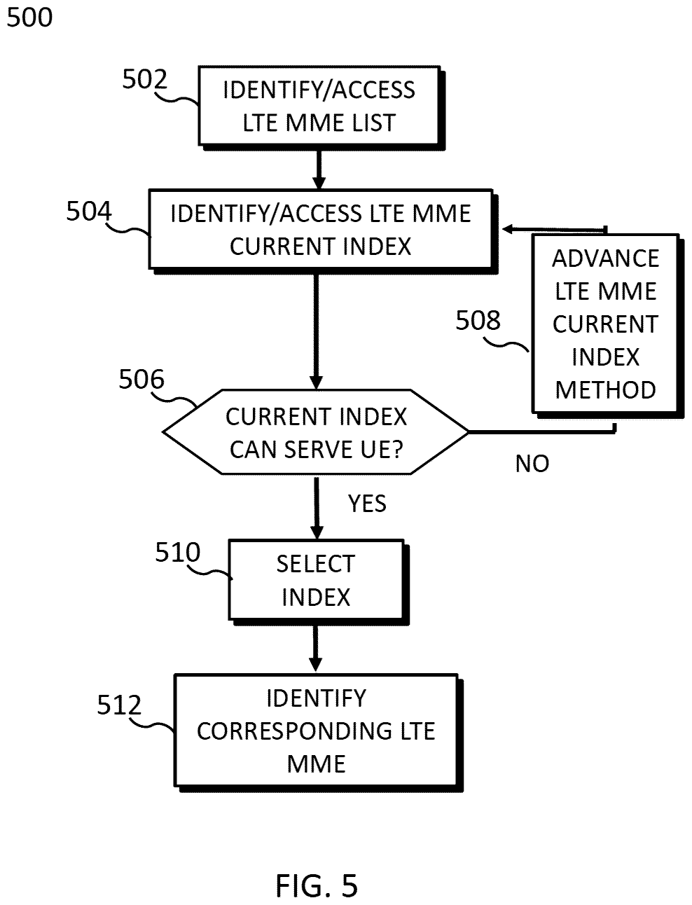

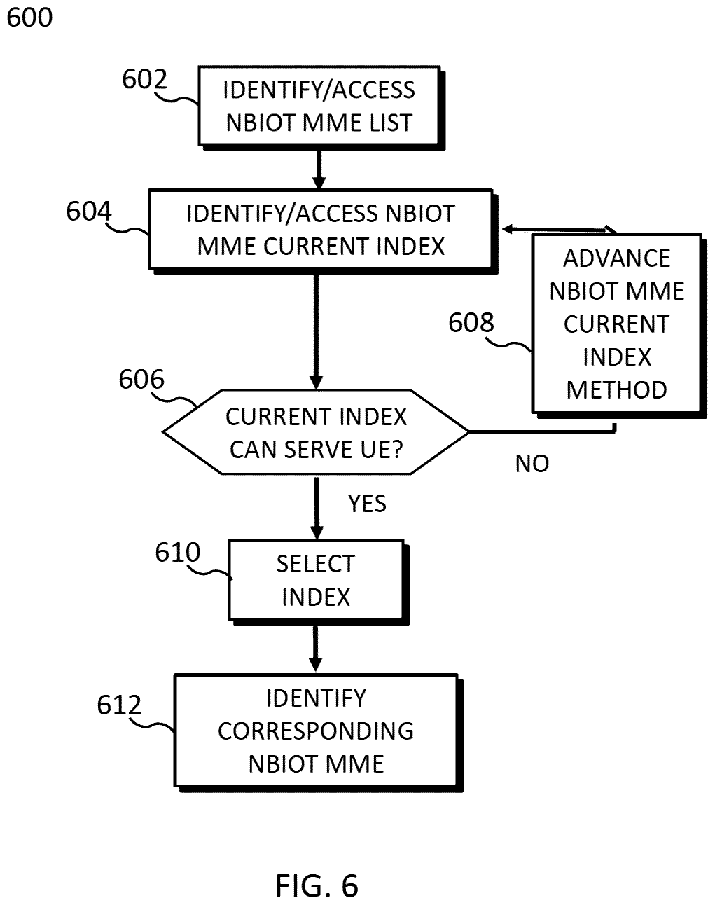

FIG. 3 is a flowchart of a method 300 of using a network system, in accordance with some embodiments. The method 300 is usable by a network system in order to help ensure that load is efficiently balanced amongst MMEs. By utilizing efficient load balancing, the method 300 helps to manage resource distribution. In some embodiments, the method 300 is able to be executed by the network system 100 (FIG. 1). In some embodiments, the method 300 is able to be executed by a network system other than the network testing system 100 (FIG. 1). In some embodiments, the method 300 is usable with the method 200 (FIG. 2). In some embodiments, the method 300 is usable with a method other than the method 200 (FIG. 2). In some embodiments, the method 300 is usable with the method 400 (FIG. 4). In some embodiments, the method 300 is usable with a method other than the method 400 (FIG. 4). In some embodiments, the method 300 is usable with the method 500 (FIG. 5). In some embodiments, the method 300 is usable with a method other than the method 500 (FIG. 5). In some embodiments, the method 300 is usable with the method 600 (FIG. 6). In some embodiments, the method 300 is usable with a method other than the method 600 (FIG. 6).

In operation 302, a service type associated with a user equipment (UE) is determined. In some embodiments, a UE sends an attach request to an MME or eNB.

In operation 304, a branching logic sequence is entered and executed. In some embodiments, if it is determined that a service type of the UE is an LTE service type, then operation 306 is carried out. In some embodiments, if it is determined that a service type of the UE is not an LTE service type, then operation 306 is not carried out. In some embodiments, if it is determined that a service type of the UE is not an LTE service type, then operation 306 is bypassed.

In operation 306, an LTE handler method is executed or called upon. In some embodiments, an LTE handler is segregated from an NB-IoT handler. In some embodiments, an LTE handler is segregated from an NB-IoT handler using separate code modules or blocks for each handler. In some embodiments, a data structure is accessed by an LTE handler. In some embodiments, a data structure is accessed by an LTE handler from local storage. In some embodiments, a data structure is accessed by an LTE handler from remote storage. In some embodiments, a data structure is accessed by an LTE handler from cache data. In some embodiments, a data structure is accessed by an LTE handler from metadata. In some embodiments, a data structure is accessed by an LTE handler remotely. In some embodiments, particular parts of a data structure are accessed by an LTE handler. In some embodiments, particular parts of a data structure are not accessed by an LTE handler. In some embodiments, particular parts of a data structure accessed by an LTE handler include an LTE MME list. In some embodiments, particular parts of a data structure not accessed by an LTE handler include an NB-IoT MME list. In some embodiments, a data structure is modified by an LTE handler. In some embodiments, particular parts of a data structure are modified by an LTE handler. In some embodiments, the data structures are data structures, or their contents, as described in operations 206 and 208, or elsewhere herein. In some embodiments, particular parts of a data structure are updated by an LTE handler. In some embodiments, particular parts of a data structure updated by an LTE handler include an index or reference pointer of a selected LTE MME or node. In some embodiments, particular parts of a data structure are not updated by an LTE handler. In some embodiments, particular parts of a data structure not updated by an LTE handler include an index or reference pointer of a selected NB-IoT MME or node. In some embodiments, the LTE handler method is the method 500 (FIG. 5). In some embodiments, the LTE handler method is a method other than the method 500 (FIG. 5).

In operation 308, operation 306 entering LTE handler method is bypassed. In some embodiments, by bypassing the LTE handler method, an LTE MME current index is not advanced. In some embodiments, separation of an LTE MME current index and an NB-IoT MME current index allows more appropriate MME usage and load balancing.

One of ordinary skill in the art would understand that additional operations are possible within method 300 in some embodiments. For example, in some embodiments, the method 300 further includes additional service type determination steps and associated handlers. In some embodiments, an order of operations of the method 300 is changed. In some embodiments, at least one operation of the method 300 is omitted.

Utilizing the method 300 helps to ensure efficient load balancing amongst MMEs. As a result, network service is more likely to remain robust and reliable.

FIG. 4 is a flowchart of a method 400 of using a network system, in accordance with some embodiments. The method 400 is usable by a network system in order to help ensure that load is efficiently balanced amongst MMEs. By utilizing efficient load balancing, the method 400 helps to manage resource distribution. In some embodiments, the method 400 is able to be executed by the network system 100 (FIG. 1). In some embodiments, the method 400 is able to be executed by a network system other than the network testing system 100 (FIG. 1). In some embodiments, the method 400 is usable with the method 200 (FIG. 2). In some embodiments, the method 400 is usable with a method other than the method 200 (FIG. 2). In some embodiments, the method 400 is usable with the method 300 (FIG. 3). In some embodiments, the method 400 is usable with a method other than the method 300 (FIG. 3). In some embodiments, the method 400 is usable with the method 500 (FIG. 5). In some embodiments, the method 400 is usable with a method other than the method 500 (FIG. 5). In some embodiments, the method 400 is usable with the method 600 (FIG. 6). In some embodiments, the method 400 is usable with a method other than the method 600 (FIG. 6).

In operation 402, a service type associated with a UE is determined. In some embodiments, a UE sends an attach request to an MME or eNB.

In operation 404, a branching logic sequence is entered and executed. In some embodiments, if it is determined that a service type of the UE is an NB-IoT service type, then operation 406 is carried out. In some embodiments, if it is determined that a service type of the UE is not an NB-IoT service type, then operation 406 is not carried out. In some embodiments, if it is determined that a service type of the UE is not an NB-IoT service type, then operation 406 is bypassed.

In operation 406, an NB-IoT handler method is executed or called upon. In some embodiments, an NB-IoT handler is segregated from an LTE handler. In some embodiments, an NB-IoT handler is segregated from an LTE handler using separate code modules or blocks for each handler. In some embodiments, a data structure is accessed by an NB-IoT handler. In some embodiments, a data structure is accessed by an NB-IoT handler from local storage. In some embodiments, a data structure is accessed by an NB-IoT handler from remote storage. In some embodiments, a data structure is accessed by an NB-IoT handler from cache data. In some embodiments, a data structure is accessed by an NB-IoT handler from metadata. In some embodiments, a data structure is accessed by an NB-IoT handler remotely. In some embodiments, particular parts of a data structure are accessed by an LTE handler. In some embodiments, particular parts of a data structure are not accessed by an NB-IoT handler. In some embodiments, particular parts of a data structure accessed by an NB-IoT handler include an NB-IoT MME list. In some embodiments, particular parts of a data structure not accessed by an LTE handler include an LTE MME list. In some embodiments, a data structure is modified by an NB-IoT handler. In some embodiments, particular parts of a data structure are modified by an NB-IoT handler. In some embodiments, the data structures are data structures, or their contents, as described in operations 206 and 208, or elsewhere herein. In some embodiments, particular parts of a data structure are updated by an NB-IoT handler. In some embodiments, particular parts of a data structure updated by an NB-IoT handler include an index or reference pointer of a selected NB-IoT MME or node. In some embodiments, particular parts of a data structure are not updated by an NB-IoT handler. In some embodiments, particular parts of a data structure not updated by an NB-IoT handler include an index or reference pointer of a selected LTE MME or node. In some embodiments, the NB-IoT handler method is the method 600 (FIG. 6). In some embodiments, the NB-IoT handler method is a method other than the method 600 (FIG. 6).

In operation 408, operation 406 entering NB-IoT handler method is bypassed. In some embodiments, by bypassing the LTE handler method, an NB-IoT MME current index is not advanced. In some embodiments, separation of an LTE MME current index and an NB-IoT MME current index allows more appropriate MME usage and load balancing.

One of ordinary skill in the art would understand that additional operations are possible within method 400 in some embodiments. For example, in some embodiments, the method 400 further includes additional service type determination steps and associated handlers. In some embodiments, an order of operations of the method 400 is changed. In some embodiments, at least one operation of the method 400 is omitted.

Utilizing the method 400 helps to ensure efficient load balancing amongst MMEs. As a result, network service is more likely to remain robust and reliable.

FIG. 5 is a flowchart of a method 500 of using a network system, in accordance with some embodiments. The method 500 is usable by a network system in order to help ensure that load is efficiently balanced amongst MMEs. By utilizing efficient load balancing, the method 500 helps to manage resource distribution. In some embodiments, the method 500 is able to be executed by the network system 100 (FIG. 1). In some embodiments, the method 500 is able to be executed by a network system other than the network testing system 100 (FIG. 1). In some embodiments, the method 500 is usable with the method 300 (FIG. 3). In some embodiments, the method 500 is usable with a method other than the method 300 (FIG. 3).

In operation 502, an LTE MME list is identified and accessed from a data structure. In some embodiments, the data structure, or its contents, is as described in operations 206 and 208, or elsewhere herein. In some embodiments, the data structure comprises a list. In some embodiments, the data structure comprises a data structure other than a list. In some embodiments, an LTE MME list comprises a listing of LTE MMEs in a particular MME pool. In some embodiments, an LTE MME list comprises a listing of LTE MMEs in multiple MME pools.

In operation 504, a current index is identified in an LTE MME index or pointer is identified and accessed from a data structure. In some embodiments, the current index is a default index or an initial index. In some embodiments, each element, identifier, member, or individual index of an LTE MME index corresponds to a member of an MME pool. In some embodiments, the data structure, or its contents, is as described in operations 206 and 208, or elsewhere herein. In some embodiments, the data structure comprises a list. In some embodiments, the data structure comprises a data structure other than a list. In some embodiments, an LTE MME index comprises an identifier of each of the LTE MMEs in an MME list. In some embodiments, a current index, selected index, or pointer is stored or persisted in a temporary storage, such as a cache, session variable, or global variable. In some embodiments, a current index, selected index, or pointer is stored or persisted in a database or data store.

In operation 506, a determination is made as to whether an MME associated with the current index is able to serve a requesting UE. In some embodiments, if the associated MME is not able to serve the UE, then operation 508 is executed. In some embodiments, if the associated MME is able to serve the UE, then operation 510 is executed. In some embodiments, the determination includes determining a current load parameter associated with an MME associated with the current index. In some embodiments, the determination includes determining a current serviceability parameter or metric associated with an MME associated with the current index. In some embodiments, the determination includes determining a current availability parameter associated with an MME associated with the current index. In some embodiments, the determination includes determining a current usage parameter associated with an MME associated with the current index.

In operation 508, a method to advance the current index is executed. In some embodiments, an index is a pointer, reference, or variable. In some embodiments, an index is a session variable, metadata variable, or the like. In some embodiments, an index is a transient variable or reference item. In some embodiments, an index is a pointer, reference, or variable that references an item or element in a list or data structure.

In operation 510, the current index is selected. In some embodiments, the current index is stored. In some embodiments, the current index is passed, communicated, or transmitted to a module for processing.

In operation 512, an LTE MME corresponding to the current index is identified. In some embodiments, a data structure includes a list of LTE MMEs. In some embodiments, the data structure includes an identifier corresponding to each LTE MME. In some embodiments, a data structure maintains a current index or pointer to an identifier.

One of ordinary skill in the art would understand that additional operations are possible within method 500 in some embodiments. In some embodiments, at least one operation of the method 500 is omitted.

Utilizing the method 500 helps to ensure efficient load balancing amongst MMEs. As a result, network service is more likely to remain robust and reliable.

FIG. 6 is a flowchart of a method 600 of using a network system, in accordance with some embodiments. The method 600 is usable by a network system in order to help ensure that load is efficiently balanced amongst MMEs. By utilizing efficient load balancing, the method 600 helps to manage resource distribution. In some embodiments, the method 600 is able to be executed by the network system 100 (FIG. 1). In some embodiments, the method 600 is able to be executed by a network system other than the network testing system 100 (FIG. 1). In some embodiments, the method 600 is usable with the method 400 (FIG. 4). In some embodiments, the method 600 is usable with a method other than the method 400 (FIG. 4).

In operation 602, an NB-IoT MME list is identified and accessed from a data structure. In some embodiments, the data structure, or its contents, is as described in operations 206 and 208, or elsewhere herein. In some embodiments, the data structure comprises a list. In some embodiments, the data structure comprises a data structure other than a list. In some embodiments, an NB-IoT MME list comprises a listing of NB-IoT MMEs in a particular MME pool. In some embodiments, an NB-IoT MME list comprises a listing of NB-IoT MMEs in multiple MME pools.

In operation 604, a current index is identified in an NB-IoT MME index or pointer is identified and accessed from a data structure. In some embodiments, the current index is a default index or an initial index. In some embodiments, each element, identifier, member, or individual index of an NB-IoT MME index corresponds to a member of an MME pool. In some embodiments, the data structure, or its contents, is as described in operations 206 and 208, or elsewhere herein. In some embodiments, the data structure comprises a list. In some embodiments, the data structure comprises a data structure other than a list. In some embodiments, an NB-IoT MME index comprises an identifier of each of the NB-IoT MMEs in an MME list. In some embodiments, a current index, selected index, or pointer is stored or persisted in a temporary storage, such as a cache, session variable, or global variable. In some embodiments, a current index, selected index, or pointer is stored or persisted in a database or data store.

In operation 606, a determination is made as to whether an MME associated with the current index is able to serve a requesting UE. In some embodiments, if the associated MME is not able to serve the UE, then operation 608 is executed. In some embodiments, if the associated MME is able to serve the UE, then operation 610 is executed. In some embodiments, the determination includes determining a current load parameter associated with an MME associated with the current index. In some embodiments, the determination includes determining a current serviceability parameter or metric associated with an MME associated with the current index. In some embodiments, the determination includes determining a current availability parameter associated with an MME associated with the current index. In some embodiments, the determination includes determining a current usage parameter associated with an MME associated with the current index.

In operation 608, a method to advance the current index is executed. In some embodiments, an index is a pointer, reference, or variable. In some embodiments, an index is a session variable, metadata variable, or the like. In some embodiments, an index is a transient variable or reference item. In some embodiments, an index is a pointer, reference, or variable that references an item or element in a list or data structure.

In operation 610, the current index is selected. In some embodiments, the current index is stored. In some embodiments, the current index is passed, communicated, or transmitted to a module for processing.

In operation 612, an NB-IoT MME corresponding to the current index is identified. In some embodiments, a data structure includes a list of NB-IoT MMEs. In some embodiments, the data structure includes an identifier corresponding to each NB-IoT MME. In some embodiments, a data structure maintains a current index or pointer to an identifier.

One of ordinary skill in the art would understand that additional operations are possible within method 600 in some embodiments. In some embodiments, at least one operation of the method 600 is omitted.

Utilizing the method 600 helps to ensure efficient load balancing amongst MMEs. As a result, network service is more likely to remain robust and reliable.

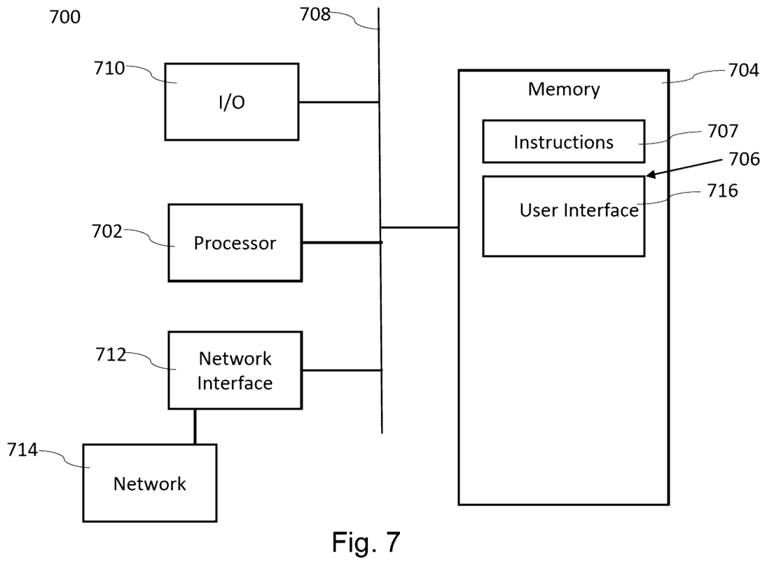

FIG. 7 is a block diagram of computer architecture 700 in accordance with some embodiments. Computer architecture 700 includes a hardware processor 702 and a non-transitory, computer readable storage medium 704 encoded with, i.e., storing, the computer program code 606, i.e., a set of executable instructions. Computer readable storage medium 704 is also encoded with instructions 707 for interfacing with external devices. The processor 702 is electrically coupled to the computer readable storage medium 704 via a bus 708. The processor 702 is also electrically coupled to an I/O interface 710 by bus 708. A network interface 712 is also electrically connected to the processor 702 via bus 708. Network interface 712 is connected to a network 714, so that processor 702 and computer readable storage medium 704 are capable of connecting to external elements via network 714. The processor 702 is configured to execute the computer program code 706 encoded in the computer readable storage medium 704 in order to cause computer architecture 700 to be usable for performing a portion or all of the operations as described herein.

In some embodiments, the processor 702 is a central processing unit (CPU), a multi-processor, a distributed processing system, an application specific integrated circuit (ASIC), or a suitable processing unit.

In some embodiments, the computer readable storage medium 704 is an electronic, magnetic, optical, electromagnetic, infrared, or a semiconductor system (or apparatus or device). For example, the computer readable storage medium 604 includes a semiconductor or solid-state memory, a magnetic tape, a removable computer diskette, a random access memory (RAM), a read-only memory (ROM), a rigid magnetic disk, or an optical disk. In some embodiments using optical disks, the computer readable storage medium 704 includes a compact disk-read only memory (CD-ROM), a compact disk-read/write (CD-R/W), or a digital video disc (DVD).

In some embodiments, the storage medium 704 stores the computer program code 606 configured to cause computer architecture 700 to perform a portion or all of the operations as described herein. In some embodiments, the storage medium 704 also stores information needed for performing a portion or all of the operations as described herein as well as information generated during performing a portion or all of the operations as described herein, such as a user interface parameter 716.

In some embodiments, the storage medium 704 stores instructions 607 for interfacing with external devices. The instructions 707 enable processor 702 to generate instructions readable by the external devices to effectively implement a portion or all of the operations as described herein.

Computer architecture 700 includes I/O interface 710. I/O interface 710 is coupled to external circuitry. In some embodiments, I/O interface 710 includes a keyboard, keypad, mouse, trackball, trackpad, or cursor direction keys for communicating information and commands to processor 702.

Computer architecture 700 also includes network interface 712 coupled to the processor 702. Network interface 712 allows computer architecture 600 to communicate with network 714, to which one or more other computer systems are connected. Network interface 712 includes wireless network interfaces such as BLUETOOTH, WIFI, WIMAX, GPRS, or WCDMA; or a wired network interface such as ETHERNET, USB, or IEEE-1394. In some embodiments, a portion or all of the operations as described herein, and information are exchanged between different computer architecture 700 via network 714.

While the above description focuses on MME selection for an eNB capable of connecting to LTE MMEs and NB-IoT MMEs, one of ordinary skill in the art would recognize that the current description is not limited this specific combination. For example, in some embodiments, where the UE attempts to communicate using LTE Machine Type Communication (LTE-M), LTE-M MMEs are includable in the MME selection process. In some embodiments, the LTE-M MMEs replace either the LTE MMEs or the NB-IoT MMEs. In some embodiments, the LTE-M MMEs are utilized in addition to the LTE MMEs and the NB-IoT MMEs. Similarly, the above description is capable of incorporating the use of category M (CAT-M) MMEs in the network.

In a situation where MMEs providing additional different types of service are utilized, additional lists, such as in operation 208 (FIG. 2), is utilized for the additional service type of MMEs. Other aspects of the Round Robin algorithm as well as the Weight Based algorithm are also able to be implemented using the third service type of MMEs. By providing the flexibility to utilize two or more different service types of MMEs, the current application is usable as technology continues to grow and expand and networks become more complex and seek to support more UEs having different types of service.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, or processors supplied with computer-readable instructions stored on computer-readable media. In at least some embodiments, dedicated circuitry includes digital or analog hardware circuits and includes integrated circuits (IC) or discrete circuits. In at least some embodiments, programmable circuitry includes reconfigurable hardware circuits including logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network or a wireless network. In at least some embodiments, the network includes copper transmission cables, optical transmission fibers, wireless transmission, routers, firewalls, switches, gateway computers or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the subject disclosure.

While embodiments of the subject disclosure have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by ‘prior to,’ ‘before,’ or the like and as long as the output from a previous process is not used in a later process. Even if the process flow is described using phrases such as ‘first’ or ‘next’ in the claims, embodiments, or diagrams, such a description does not necessarily mean that the processes must be performed in the described order.

### Supplemental Note 1

A system for selecting a mobile management entity (MME) includes a non-transitory computer readable medium configured to store instructions thereon. The system further includes a processor connected to the non-transitory computer readable medium. The processor is configured to execute the instructions for determining a pool of MMEs available for connecting to a user equipment (UE). The processor is further configured to execute the instructions for identifying, from the pool of MMEs, a plurality of lists of MMEs, wherein each of the plurality of lists of MMEs includes only MMEs having a same service type. The processor is further configured to execute the instructions for determining a service type of the UE. The processor is further configured to execute the instructions for selecting a first MME from the pool of MMEs using a node selection algorithm, wherein the node selection algorithm is executed for a single list of the plurality of lists of MMEs, and the service type of the single list matches the service type of the UE. The processor is further configured to execute the instructions for connecting the UE to the first MME.

### Supplemental Note 2

The system of Supplemental Note 1, wherein the plurality of lists of MMEs comprises a first list including MMEs configured to provide long term evolution (LTE) service, and a second list including MMEs configured to provide narrowband Internet of Things (NB-IoT) service.

### Supplemental Note 3

The system of Supplemental Note 1 or 2, wherein the node selection algorithm comprises a Round Robin algorithm.

### Supplemental Note 4

The system of any of Supplemental Notes 1-3, wherein the node selection algorithm comprises a Weight Based algorithm.

### Supplemental Note 5

The system of any of Supplemental Notes 1-4, wherein the processor is further configured to execute the instructions for determining whether prior MME information exists.

### Supplemental Note 6

The system of any of Supplemental Notes 1-5, wherein the processor is further configured to execute the instructions for selecting an MME from the pool of MMEs in response to existence of the prior MME information.

### Supplemental Note 7

The system of any of Supplemental Notes 1-6, wherein the processor is further configured to execute the instructions for determining the node selection algorithm based on a connection capacity of each of the MMEs in a list of the plurality of lists corresponding to the service type of the UE.

### Supplemental Note 8

A method of selecting a mobile management entity (MME) includes determining a pool of MMEs available for connecting to a user equipment (UE). The method further includes identifying, from the pool of MMEs, a plurality of lists of MMEs, wherein each of the plurality of lists of MMEs includes only MMEs having a same service type. The method further includes determining a service type of the UE. The method further includes selecting a first MME from the pool of MMEs using a node selection algorithm, wherein the node selection algorithm is executed for a single list of the plurality of lists of MMEs, and the service type of the single list matches the service type of the UE. The method further includes connecting the UE to the first MME.

### Supplemental Note 9

The method of Supplemental Note 8, wherein the plurality of lists of MMEs comprises a first list including MMEs configured to provide long term evolution (LTE) service, and a second list including MMEs configured to provide narrowband Internet of Things (NB-IoT) service.

### Supplemental Note 10

The method of Supplemental Note 8 or 9, wherein the node selection algorithm comprises a Round Robin algorithm.

### Supplemental Note 11

The method of any of Supplemental Notes 8-10, wherein the node selection algorithm comprises a Weight Based algorithm.

### Supplemental Note 12

The method of any of Supplemental Notes 8-11, wherein the processor is further configured to execute the instructions for determining whether prior MME information exists.

### Supplemental Note 13

The method of any of Supplemental Notes 8-12, wherein the processor is further configured to execute the instructions for selecting an MME from the pool of MMEs in response to existence of the prior MME information.

### Supplemental Note 14

The method of any of Supplemental Notes 8-13, wherein the processor is further configured to execute the instructions for determining the node selection algorithm based on a connection capacity of each of the MMEs in a list of the plurality of lists corresponding to the service type of the UE.

### Supplemental Note 15

A non-transitory computer readable medium configured to store instructions thereon. The instructions are configured to cause a processor to perform determining a pool of MMEs available for connecting to a user equipment (UE). The instructions are configured to cause a processor to perform identifying, from the pool of MMEs, a plurality of lists of MMEs, wherein each of the plurality of lists of MMEs includes only MMEs having a same service type. The instructions are configured to cause a processor to perform determining a service type of the UE. The instructions are configured to cause a processor to perform selecting a first MME from the pool of MMEs using a node selection algorithm, wherein the node selection algorithm is executed for a single list of the plurality of lists of MMEs, and the service type of the single list matches the service type of the UE. The instructions are configured to cause a processor to perform connecting the UE to the first MME.

### Supplemental Note 16

The non-transitory computer readable medium of Supplemental Note 15, wherein the plurality of lists of MMEs comprises a first list including MMEs configured to provide long term evolution (LTE) service, and a second list including MMEs configured to provide narrowband Internet of Things (NB-IoT) service.

### Supplemental Note 17

The non-transitory computer readable medium of Supplemental Note 15 or 16, wherein the node selection algorithm comprises a Round Robin algorithm.

### Supplemental Note 18

The non-transitory computer readable medium of any of Supplemental Notes 15-17, wherein the node selection algorithm comprises a Weight Based algorithm.

### Supplemental Note 19

The non-transitory computer readable medium of any of Supplemental Notes 15-18, wherein the instructions are configured to cause the processor to: determine whether prior MME information exists; and select an MME from the pool of MMEs in response to existence of the prior MME information.

### Supplemental Note 20

The non-transitory computer readable medium of any of Supplemental Notes 15-19, wherein the instructions are configured to cause the processor to determine the node selection algorithm based on a connection capacity of each of the MMEs in a list of the plurality of lists corresponding to the service type of the UE.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system for selecting a mobile management entity (MME) comprising:
a non-transitory computer readable medium configured to store instructions thereon; and
a processor connected to the non-transitory computer readable medium, wherein the processor is configured to execute the instructions for:
determining a pool of MMEs available for connecting to a user equipment (UE);
identifying, from the pool of MMEs, a plurality of lists of MMEs, wherein each of the plurality of lists of MMEs includes only MMEs having a same service type;
determining a service type of the UE;
selecting a first MME from the pool of MMEs using a node selection algorithm, wherein the node selection algorithm is executed for a single list of the plurality of lists of MMEs, and the service type of the single list matches the service type of the UE; and
connecting the UE to the first MME.

2. The system of claim 1, wherein the plurality of lists of MMEs comprises:
a first list including MMEs configured to provide long term evolution (LTE) service, and
a second list including MMEs configured to provide narrowband Internet of Things (NB-IoT) service.

3. The system of claim 1, wherein the node selection algorithm comprises a Round Robin algorithm.

4. The system of claim 1, wherein the node selection algorithm comprises a Weight Based algorithm.

5. The system of claim 1, wherein the processor is further configured to execute the instructions for determining whether prior MME information exists.

6. The system of claim 5, wherein the processor is further configured to execute the instructions for selecting an MME from the pool of MMEs in response to existence of the prior MME information.

7. The system of claim 1, wherein the processor is further configured to execute the instructions for determining the node selection algorithm based on a connection capacity of each of the MMEs in a list of the plurality of lists corresponding to the service type of the UE.

8. A method of selecting a mobile management entity (MME), the method comprising:
determining a pool of MMEs available for connecting to a user equipment (UE);
identifying, from the pool of MMEs, a plurality of lists of MMEs, wherein each of the plurality of lists of MMEs includes only MMEs having a same service type;
determining a service type of the UE;
selecting a first MME from the pool of MMEs using a node selection algorithm, wherein the node selection algorithm is executed for a single list of the plurality of lists of MMEs, and the service type of the single list matches the service type of the UE; and
connecting the UE to the first MME.

9. The method of claim 8, wherein the plurality of lists of MMEs comprises:
a first list including MMEs configured to provide long term evolution (LTE) service, and
a second list including MMEs configured to provide narrowband Internet of Things (NB-IoT) service.

10. The method of claim 8, wherein the node selection algorithm comprises a Round Robin algorithm.

11. The method of claim 8, wherein the node selection algorithm comprises a Weight Based algorithm.

12. The method of claim 8, wherein the processor is further configured to execute the instructions for determining whether prior MME information exists.

13. The method of claim 12, wherein the processor is further configured to execute the instructions for selecting an MME from the pool of MMEs in response to existence of the prior MME information.

14. The method of claim 8, wherein the processor is further configured to execute the instructions for determining the node selection algorithm based on a connection capacity of each of the MMEs in a list of the plurality of lists corresponding to the service type of the UE.

15. A non-transitory computer readable medium configured to store instructions thereon, wherein the instructions are configured to cause a processor to perform operations comprising:
determining a pool of MMEs available for connecting to a user equipment (UE);
identifying, from the pool of MMEs, a plurality of lists of MMEs, wherein each of the plurality of lists of MMEs includes only MMEs having a same service type;
determining a service type of the UE;
selecting a first MME from the pool of MMEs using a node selection algorithm, wherein the node selection algorithm is executed for a single list of the plurality of lists of MMEs, and the service type of the single list matches the service type of the UE; and
connecting the UE to the first MME.

16. The non-transitory computer readable medium of claim 15, wherein the plurality of lists of MMEs comprises:
a first list including MMEs configured to provide long term evolution (LTE) service, and
a second list including MMEs configured to provide narrowband Internet of Things (NB-IoT) service.

17. The non-transitory computer readable medium of claim 15, wherein the node selection algorithm comprises a Round Robin algorithm.

18. The non-transitory computer readable medium of claim 15, wherein the node selection algorithm comprises a Weight Based algorithm.

19. The non-transitory computer readable medium of claim 15, wherein the instructions are configured to cause the processor to:
determine whether prior MME information exists; and
select an MME from the pool of MMEs in response to existence of the prior MME information.

20. The non-transitory computer readable medium of claim 15, wherein the instructions are configured to cause the processor to determine the node selection algorithm based on a connection capacity of each of the MMEs in a list of the plurality of lists corresponding to the service type of the UE.
